(19) United States
(12) Patent Application Publication
(10) Pub. No.: US 2016/0197840 A1
(43) Pub. Date: Jul. 7, 2016

(54) Set Up of New Paths Between Border Nodes of a Client Communications Network Through a Server Communications Network

(71) Applicant: TELEFONAKTIEBOLAGET L M ERICSSON (PUBL), Stockholm (SE)

(72) Inventors: Diego CAVIGLIA, Vällingby (SE); Daniele CECCARELLI, Sollentuna (SE); Joel HALPERN, Leesburg, VA (US); Paolo REBELLA, Genova (IT)

(21) Appl. No.: 14/898,907

(22) PCT Filed: Jun. 25, 2013
(86) PCT No.: PCT/EP2013/063254

§ 371 Date: Dec. 16, 2015

Related U.S. Application Data
(60) Provisional application No. 61/836,844, filed on Jun. 19, 2013.

(51) Int. Cl. H04L 12/911; H04L 29/06

(52) U.S. Cl. CPC H04L 47/70; H04L 65/1069; H04L 67/42

(57) ABSTRACT

A method for setting up a new path for carrying traffic between border nodes of a client communications network through a server communications network. The method comprises, at a border node of the client communications network: receiving a request for reservation of resources from a first client node of the client communications network; determining that the border node does not have a path for carrying traffic through the server communications network having sufficient resources to meet the request; and, in response, initiating set up of a new path for carrying traffic between border nodes of the client communications network through the server communications network.

### TECHNICAL FIELD

The present invention relates to a method and apparatus for setting up a new path for carrying traffic between border nodes of a client communication networks through a server communications network.

### BACKGROUND

Overlay networks provide a way of integrating communications networks typically operating at different layers whilst limiting the amount of routing information advertised throughout the client network.

FIG. 1 illustrates a schematic view of an example overlay network. The client communications network 10, which in this example is an IP network, is connected to a core or server communications network 20, in this case an optical, wavelength-switched network, by a plurality of overlay or border nodes 30. These border nodes 30 are part of the client network 10 but can also communicate with the server network 20. Both the client network 10 and the server network 20 has a separate control plane and network management system (NMS) although, for ease of illustration, only the client NMS 40 is illustrated in FIG. 1.

The interface between the border nodes 30 and the server network 20 is defined according to a user defined network interface (UNI) which is designed to prevent routing information of the server network 20 flooding the client network 10. When an end-to-end path, such as an LSP (label switched path), is set up between a pair of border nodes 30 through the server network 20, which is sometimes referred to as a “tunnel”, this connectivity is advertised in the client network 10. The other client nodes are not aware that this path passes through the server network 20, but can nonetheless use the path to determine a routing and establish a connection with another client node in the client network 10.

Thus, in this way, client network traffic may be transmitted via a server network 20 whilst the amount of routing information advertised in the client network is limited. This means that the amount of bandwidth required to advertise the routing information and the amount of processing power required to make routing decisions can be reduced. This, in turn, increases the scalability of the overlay network and its ease of use.

If and when the client network operator (NMS 40) determines that a new path needs to be established through the server network 20, to meet demands for bandwidth, the network operator asks a border node 30 to set up a new end-to-end path through the server network 20. This path is then advertised in the client network 10, and can be used in subsequent routings between client nodes.

### SUMMARY

The Applicant has appreciated however that it would be desirable if new end-to-end paths (i.e. between nodes in the client network that are not border nodes) through the server network could be set up automatically by a client node, when needed, without having to wait for the network operator to manually trigger the set-up of a new path through the server network.

A difficulty is however that, in existing overlay networks, client nodes cannot typically request the set-up of new end-to-end paths through the server network. The majority of the client nodes (all those which are not border nodes) are not aware that it may be possible for a new path to be established via the server network and furthermore, even if they were, those client nodes are not aware of which client nodes are border nodes and therefore are capable of setting up a new path through the server network.

The Applicant has further appreciated that it would be disadvantageous to advertise throughout the client network which client nodes are the border nodes, since given a client network may comprise a very large number of nodes, this may require a substantial amount of bandwidth.

According to the present invention there is provided a method for setting up a new path for carrying traffic between border nodes of a client communications network through a server communications network. The method comprises, at a border node of the client communications network, receiving a request for reservation of resources from a first client node of the client communications network; determining that the border node does not have a path through the server communications network having sufficient resources to meet the request; and, in response, initiating set up of a new path for carrying traffic between border nodes of the client communications network through the server communications network.

Embodiments of the present invention have the advantage that a new path through the server network can be set up automatically, when necessary, without requiring a manual trigger from a network operator. This can lead to more efficient set up of new end-to-end paths through the server network and can reduce operational costs. Furthermore, embodiments of the present invention are particularly advantageous for use in software defined networks (SDN), where by virtue of the present invention, advantageously, new end-to-end paths through the server network may be triggered by software applications running over client nodes.

In a first embodiment of the present invention, the step of initiating set up of a new path for carrying traffic between border nodes of the client communications network comprises initiating set up of a new path between the first border node and another border node through the server communications network.

In a second embodiment of the present invention, the step of initiating set up a new path between border nodes of the client communications network comprises identifying a second border node of the client communications network and initiating set up of a new path between the second border node and another border node through the server communications network.

The second border node may not have a path for carrying traffic through the server communications network.

Preferably, the step of initiating set up a new path for carrying traffic between the second border and another border node through the server communications network comprises sending a message to the first client node identifying the second border node. Preferably, the message further comprises an indication that the first client node should re-send its request for reservation of resources via the second border node.

Preferably, the step of identifying the second border node of the client communications network comprises identifying the second border node from a plurality of border nodes of the client communications network based on the proximity of the second border node to the first client node. Advantageously, therefore, a border node which may be reached from the first client node by a shorter path than other border nodes may be selected. This may result in a more efficient routing.

In a further embodiment of the present invention, the request for reservation of resources from the first client node comprises an indication that the border node should initiate set up a new path for carrying traffic between border nodes of the client communications network through the server communications network. This indication is advantageous, since it allows the border node to be configured so as not always to initiate set up of a new path through the server network where it does not have a path through the server network which can meet a request for reservation of resources. This is particularly advantageous where the border node is a second border node (identified previously by a first border node) which does not have a path for carrying traffic through the server network.

The new path may be a label switched path (LSP). The request for resources may be a signalling message such as an RSVP-TE message.

According to a second aspect of the present invention, there is also provided a method for setting up a new path for carrying traffic between border nodes of a client communications network through a server communications network. The method comprises, at a first client node of the communications network: receiving a message from a first border node of the client communications network identifying a second border node of the communications network; and sending a request for reservation of resources via the second border node.

Preferably, the message from the first border node of the client communications network further indicates that the first client node should resend a request for reservation of resources via the second border node.

Preferably, the request for reservation of resources via the second border node comprises an indication of the second border node.

The request for reservation of resources via the second border node may comprise an RSVP-TE request. The RSVP-TE request may include a loose explicit hop identifying the second border node.

Preferably, the request for reservation of resources via the second border node comprises an indication that the second border node should initiate set up of a new path between the second border node and another border node through the server communications network. Note that the indication may simply be an indication in the request of the second border node. This has the advantage of minimising the size of the request and therefore the bandwidth required to transmit the request.

There is further provided apparatus for a border node of a client communications network, the border node being coupled to a server communications network. The apparatus comprises an interface for receiving a request for reservation of resources from a first client node of the client communications network. The apparatus further comprises a controller configured to: determine that border node does not have a path through the server communications network having sufficient resources to meet the request; and, in response, initiate set up of a new path between border nodes of the client communications network through the server communications network.

There is further provided apparatus for a client node of a client communications network. The apparatus comprises an interface for receiving a message from a first border node of the client communications network identifying a second border node of the client communications network. The apparatus further comprises a controller configured to, in response, form a request for reservation of resources comprising an indication that the request should be sent via the second border node.

There is also provided a border node for coupling to a server communications network comprising apparatus as described above. There is further provided a client node comprising apparatus as described above.

There is also provided a client communications network comprising a border node as described above, and optionally, in addition, a first client node as described above.

### BRIEF DESCRIPTION OF THE DRAWINGS

A preferred embodiment of the present invention will now be described, by way of example only, and with reference to the following Figures in which:

FIG. 1 illustrates an overlay network according to the prior art;

FIG. 2 illustrates an overlay network according to an embodiment of the present invention showing the connectivity advertised in the client network;

FIG. 3 illustrates an overlay network according to an embodiment of the present invention showing signalling of an RSVP-TE request;

FIG. 4 is a flow chart according to an embodiment of the present invention;

FIG. 5 is a flow chart according to a first embodiment of the present invention;

FIG. 6 is a flow chart according to a second embodiment of the present invention;

FIG. 7 illustrates an overlay network according to a preferred embodiment of the present invention showing the failure of an RSVP-TE request;

FIG. 8 illustrates an overlay network according to a preferred embodiment of the present invention showing signalling of a re-sent RSVP-TE request;

FIG. 9 illustrates an overlay network according to a preferred embodiment of the present invention showing new connectivity between border nodes of the client network;

FIG. 10 is a flow chart according to a preferred embodiment of the present invention;

FIG. 11 is a schematic view of a client node according to an embodiment of the present invention;

FIG. 12 is a schematic view of a border node according to an embodiment of the present invention.

### DETAILED DESCRIPTION

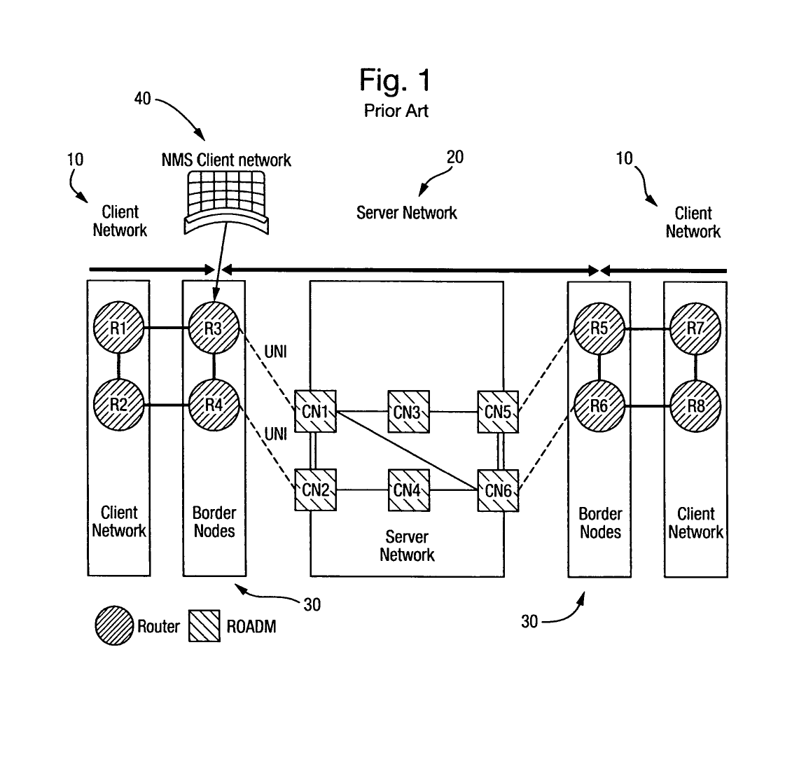

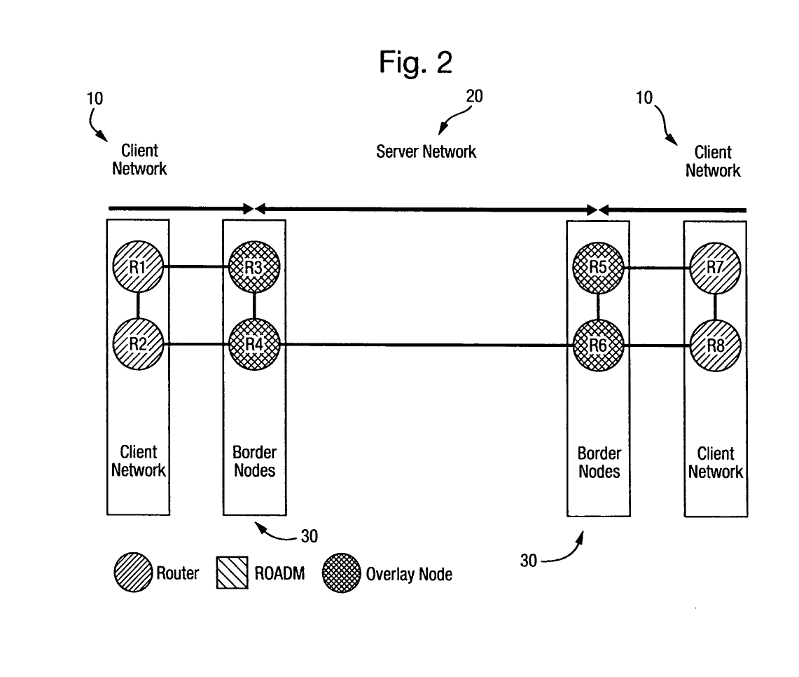

FIG. 2 is a schematic view of an overlay network according to an embodiment of the present invention. The overall structure of the overlay network in FIG. 2 is similar to that of the overlay network shown in FIG. 1, except that no client NMS is shown. As will be explained in more detail below, unlike the prior art, embodiments of the present invention do not require a client NMS to trigger the set-up of new end-to-end paths through the server network 20. However, it should be appreciated that in some embodiments of the present invention a client NMS may still be present, performing for example different functions. Both the client network 10 and the server network 20 are connection-oriented networks.

In this example, as in FIG. 1, the client network 10 is an IP network and the server network 20 is an optical, wavelength-switched network. However, in alternative embodiments, the client/server networks may comprise any type of communications network. IP over optical is a common case where overlay networks are used. However, others exist such as but not limited to OTN (Optical transport networks) over optical and SDH over optical. Moreover, it should be appreciated that overlay networks may be used to integrate any two optical networks, even two optical networks of the same technology type, where there is a client/server relationship between the networks. The two networks may use the same or routing protocol or different routing protocols.

In FIG. 2, the client network 10 comprises a plurality of client nodes R1-R8 which comprise routers, and the server network 20 comprises a plurality of server nodes CN1 to CN6 (not shown in FIG. 2), which in this case comprise ROADM nodes (reconfigurable optical add drop multiplexers). There are therefore, in this example, eight nodes in the client network 10 and six nodes in the server network 20. However, it should be appreciated that the client and server networks 10, 20 may each comprise many more nodes. The client nodes are connected by links which may comprise for example optical fibre. Similarly, although not shown in FIG. 2, the server nodes are connected by links, which may also comprise for example optical fibre. The client network 10 and the server network 20 may use different routing protocols, such as a link state routing protocol in the client network 10 and BGP (Border Gateway Protocol) in the server network 20.

In FIG. 2, the topology of the server network 20 is not shown, but the connectivity between border nodes 30 of the client network 10 through the server network 20 is shown. In this example, the client network 10 comprises two portions which are connected via the server network 20. The first portion comprises four client nodes: R1, R2, R3 and R4. Although unknown to the other client nodes, two of these client nodes (R3 and R4) are border nodes which are each coupled to an adjacent node in the server network. These border nodes 30 can participate in both the routing exchanges in the client network 10 and the routing exchanges in the server network 20, and therefore have access to routing information of the client network 10 and routing information of the server network 20. The other portion of the client network 10 also comprises four client nodes R5, R6, R7 and R8 and again two of these nodes (R5 and R6) are border nodes 30, which similarly have access to routing information of the client network 10 and routing information of the server network 20.

The connectivity between the client nodes R1 to R8 is indicated in FIG. 2 by solid black lines. Each of the solid black lines indicates a path for carrying client traffic between client nodes. It can be seen that, in this example, there is only one path between the two portions of the client network: between border nodes R4 and R6. In this example, this path is in the form of a label switched path (LSP). Although not shown in FIG. 2, this path passes through at least one node in the server network 20.

The existence of these paths, including the path between border nodes R4 and R6,is communicated to the nodes in the client network 10 and according to the routing protocol used by the client network 10 these paths may be used in routing decisions made by client nodes.

As will be understood by those skilled in the art, when a client node (sometimes referred to as an ingress node) wishes to establish a connection with another client node (often referred to as a destination node, or an egress node), typically that client node initially sends a request for reservation of resources such as bandwidth required for the connection to the destination node. Note that the destination node may be the ultimate destination for traffic to be sent via the connection or an exit node from the client network 10 via which the ultimate destination can be reached. This request may be in the form of a RSVP-TE signalling request. The request is typically routed from the client node to the destination node via a number of intermediate client nodes using the routing information of the client network 10. Each client node, on receipt of the request, determines whether a path to a next client node has sufficient resources to meet the request and, if so, forwards the request to that client node. Typically, the request does not specify each intermediate client node, but only specifies the destination node. Each intermediate client node may determine the next client node based on routing information of the client network. If the request reaches the destination node, then the connection between the client node and the destination node is established, and the requested resources are reserved along the connection. This means that the client node may now send traffic through the connection, with the guarantee that the traffic will reach the destination node with a desired quality of service (e.g. within a predetermined time).

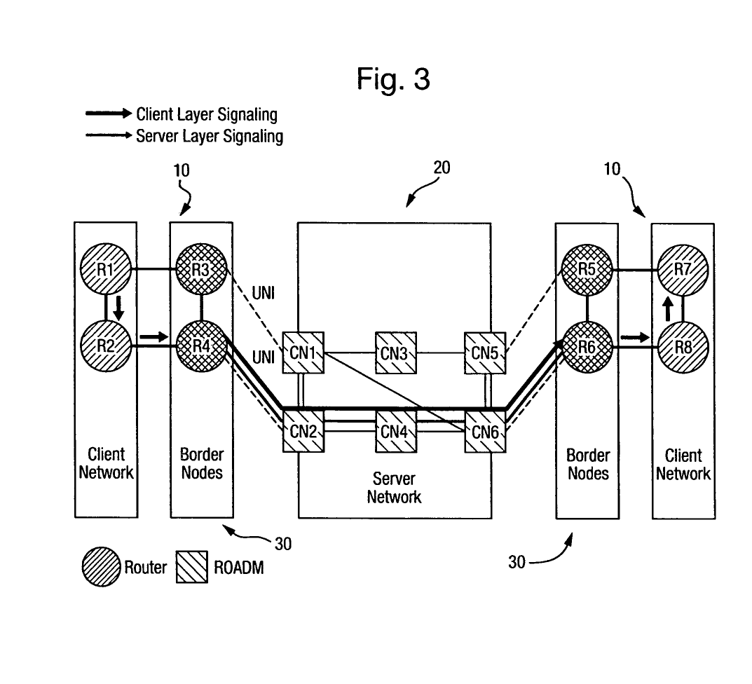

By way of illustration, FIG. 3 illustrates an example where client node R1 wishes to establish a connection with client node R7.

As indicated by the solid arrows in FIG. 3, an RSVP-TE request is passed from client node R1 to client node R2 and then to client node R4 which is a border node 30. The RSVP-TE request is then passed from border node R4 to border node R6. The RSVP-TE request is not however passed directly between R4 and R6. The RSVP-TE request is passed through the server network 30. FIG. 3 shows the topology of the server network and it can be seen that in this example the established path between border nodes R4 and R6 passes through server nodes CN2, CN4 and CN6. The RSVP-TE request is thus passed from border node R4 to server node CN2, to server node CN4 and then to server node CN6, from which the RSVP-TE request is passed to client node R8 and then to client node R7.

In this case, the RSVP-TE request is successful and a signalling message is sent back to client node R1 indicating that the requested resources have been reserved, and therefore that a connection between R1 and R7 is now established. Traffic may now be sent from client node R1 to client node R7 through the connection.

However, in some cases there may not be sufficient resources on a path between the border nodes (here R4 and R6), through the server network, to meet the request for reservation of resources. For example, the path may not have sufficient spare bandwidth to meet the request. In these cases, according to embodiments of the present invention, the border node which receives the request for reservation of resources, initiates set-up of a new path between border nodes 30 of the client network 10 through the server network 20.

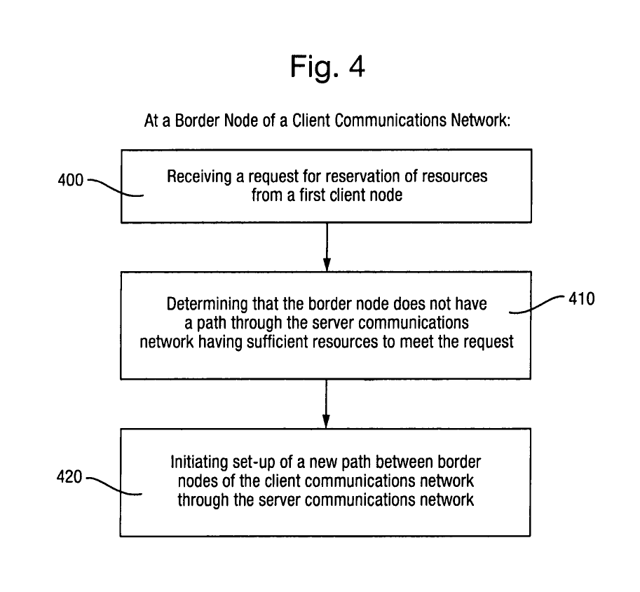

A flow chart illustrating steps according to an embodiment of the present invention is illustrated in FIG. 4. At step 400, a border node (in this case having a path for carrying traffic through the server network) receives a request from a first client node for reservation of resources. At step 410 it is determined that the path does not have sufficient resources to meet the request. Then, at step 420, in response, the border node initiates set up a new path between border nodes of the client network 10 through the server network 20.

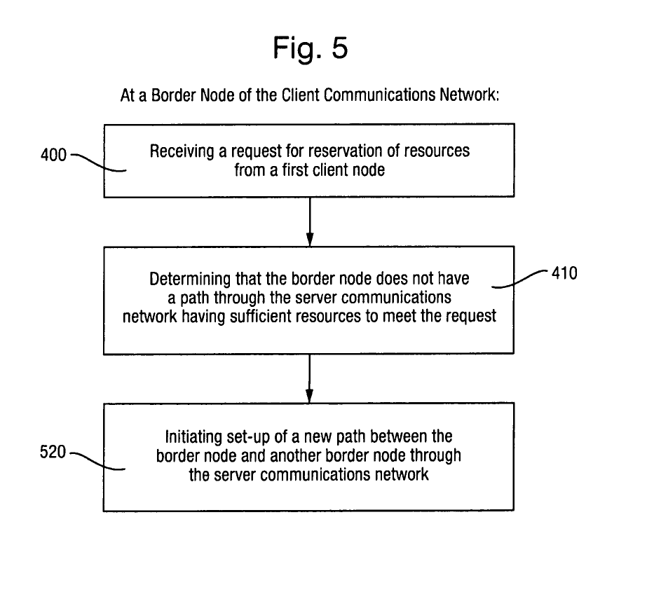

In a first embodiment of the present invention, as illustrated in the flow chart of FIG. 5, at step 520, the border node initiates set up a new path from that border node through the server communications network 20.

By way of example, referring to FIG. 3, if the path between border nodes R4 and R3 does not have sufficient resources to meet the request, border node R4 (without receiving a trigger from a network operator) may preferably determine whether a new end-to-end path can be set up through the server network, between itself and another border node 30 in the other portion of the client network 10. This new end-to-end path could be a new path between the same border nodes—i.e. border nodes R4 and R6, or a new path between border node R4 and a different border node—e.g. border node R5. This may be done by border node R4 examining routing information of the server network 20.

If a new end-to-end path can be set-up from border node R4, then border node R4 may initiate set up of the new path in a manner similar to the prior art, where border nodes 30 are asked to set-up new paths through the server network 20 by a client network operator. There are, at present, two main approaches by which client border nodes 30 may request set up of new paths through a server network 20.

In the first, the client border node sends a signal to its neighbour node in the server network 30 asking it to compute a new path between itself and a second border node in a second portion of the client network (connected to the first portion of the client network by the server network). The server node computes a path therebetween and sets up the new path, for example in the form of a label switched path (LSP). This may be done by signalling as known to those skilled in the art.

For example, in the example of FIG. 3, a new path may be set up between client border nodes R4 and R6 via server nodes CN2, CN1 and CN6. Or a new path could be set up between client border node R4 and client border node R5, for example via CN2, CN4, CN6 and CN5.

In another approach, which is presently being defined in the IETF (Internet Engineering task force), sets of virtual links between any pair of border nodes in the server network are pre-computed and communicated to the border nodes 30 in the client network 10. Note that the border nodes in the server network 20 are defined as those server nodes which neighbour or are adjacent the border nodes 30 in the client network 10. That is, those server nodes which are coupled to a border node in the client network 10 with no other server node therebetween. These border nodes however do not have access to the routing information in the client network 10. When a client border node wishes to set up a new path through the server network 20, that border node can select a virtual link and ask its associated border node in the server network 20 to set up a new path according to the link, using signalling as in the first approach.

Once a new path has been set up (assuming the new path does have sufficient resources to meet the client node's RSVP-TE request), the RSVP-TE request may be forwarded or passed via that path to the next client node. Note that the new path may also be communicated to the other client nodes, so that the new path may be used in subsequent routings between client nodes.

For example, referring to FIG. 3, the RSVP-TE request may be passed from border node R4 to say border node R6 via the new path through the server network 20. The RSVP-TE request may then be passed onto client node R8 and from there onto destination client node R7. As before, the client node (client node R1) which initiated the request (assuming the request reaches the destination node) may then be sent a signalling message confirming that the requested resources have been reserved and that the connection has been established. Traffic may now be sent from client node R1 to destination client node R7 through the connection.

If however the border node cannot set up a new path through the server network, preferably, according to a second embodiment of the present invention, the border node attempts to initiate set up of a new path through the server network from a different (second) border node. It should be appreciated that in an alternative embodiment, instead of first attempting to set up a new path through the server network from itself, the border node may first, or only, attempt to set up a new path through the server network from a different border node

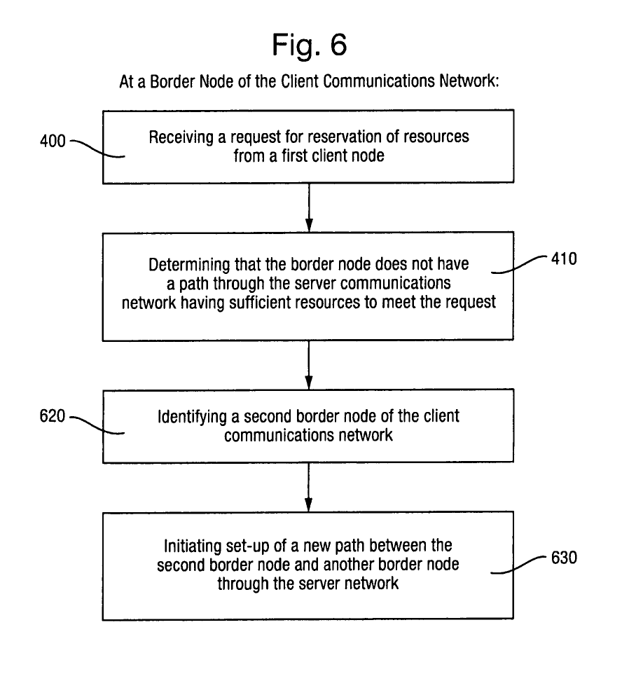

FIG. 6 illustrates a flow chart according to a second embodiment of the present invention. At step 400, a border node receives a request for reservation of resources from a first client node. At step 410, it is determined that the border node does not have a path through the server network which can meet the request. At step 620, the border node identifies a second border node, which may be able to set up a new path for carrying traffic through the server network which can meet the request. At step 630, the border node initiates set up a new path from the second border node through the server network.

The border node may initiate set up of a new path from the second border node in a number of ways.

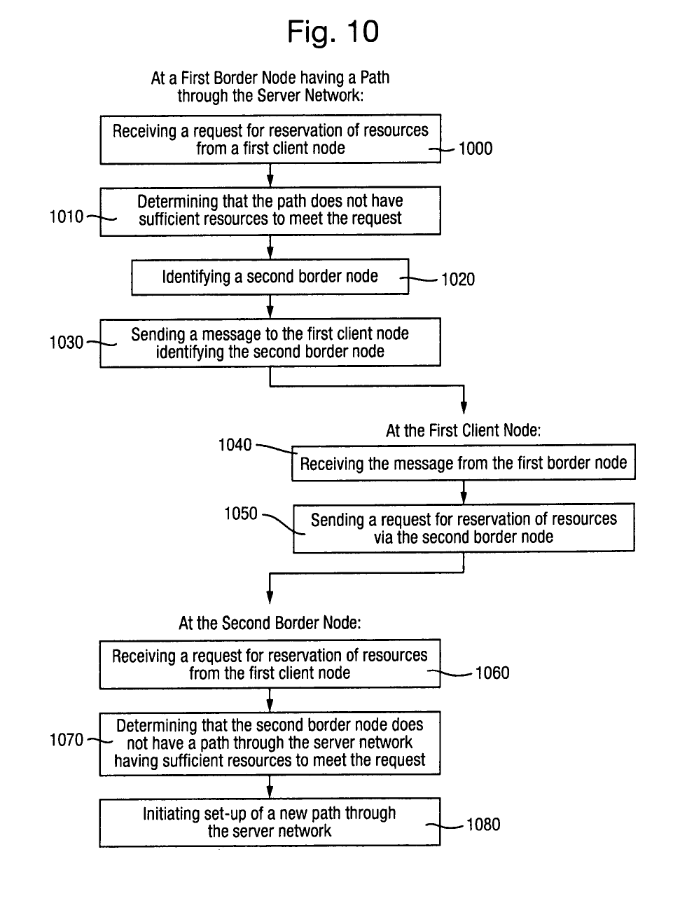

In a preferred embodiment, as illustrated in the flow chart of FIG. 10, the border node initiates set up of a new path from the second border node, through the server network, by, at step 1030, sending the first client node a message identifying the second border node. Preferably, this message further indicates that the first client node should re-send the request for reservation of resources via the second border node.

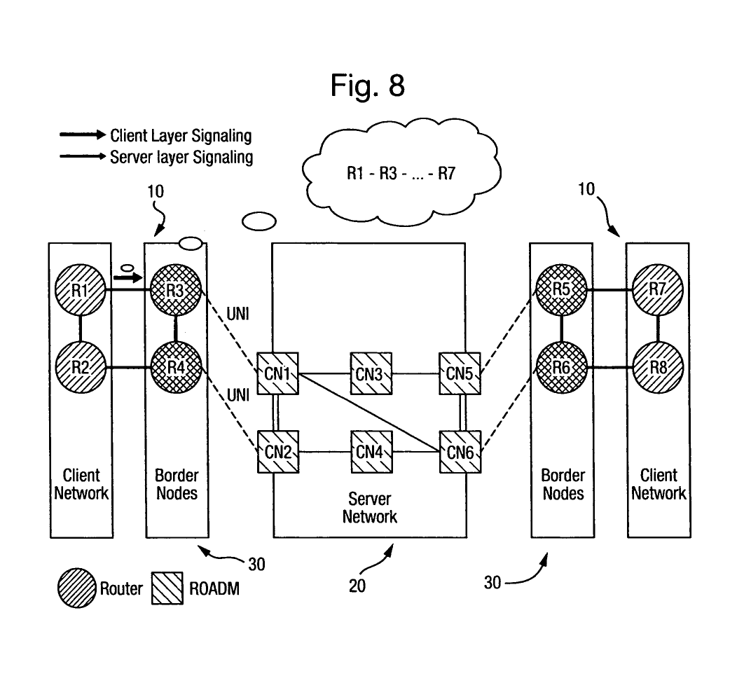

FIG. 8 illustrates an example according to a preferred embodiment of the present invention. In this example, if the path between border nodes R4 and R6 does not have sufficient resources to meet the request for reservation of resources from client node R1, border node R4 sends a failure message back to client node R1 indicating that the request has failed. This message may also be referred to as a “crankback” message. This signalling is indicated by the solid black arrows. In this example, the failure message is sent back to the client node via the same intermediate nodes through which the initial request for reservation of resources was passed.

Before the failure message is sent however, border node R4 determines whether there is a different border node which may be able to set up a new path through the server network 20 which can meet the request for reservation of resources. Note that, at present, this different border node may not have a path through the server network. This may be achieved by referring to routing information of the client and server networks 10 20. Since as explained above the border nodes 30 of the client network 10 are coupled to the server network 20, the border nodes have access to routing information of the server network 30 as well as routing information of the client network 10. This means that the border nodes 30 can determine which of the other client nodes are border nodes 30—i.e. client nodes which interface the server network 20 and are capable of setting up a new path through the server network.

If a different border node is identified then that border node is indicated in the failure message. This means that client node R1 can re-send the request for reservation of resources via the identified border node, which may be able to meet the request. Without the message identifying this node, since only paths through the server network 20 which are set up are advertised in the client network 10, the client node may not know that sending the request via the identified border node may result in the request being successful. It should be noted that, in this example, the indication that the request has failed, in combination with the identification of the second border node, may provide an indication to the client node that it should resend its request for reservation of resources via the border node identified in the message.

Preferably, the border node identifies a different (second) border node based on the proximity of the second border node to the first client node.

For example, if there are a plurality of different border nodes which may be able to set up a new path which can meet the RSVP-TE request, preferably the first border node indicates in the failure message the different border node which is closest to the client node (i.e. that other border node which can be reached from the client node by the shortest path). This may be determined by consultation of the routing information of the server network 20, and may produce an optimum routing between the client node and the destination node.

In the example of FIG. 8, the failure message sent back to client node R1 from border node R4 identifies client node R3. Note that client node R3 does not at present have a path through the server network 20. Client node R1 receives the failure message and re-sends the request for reservation of resources to destination node R7. Again, this request is sent in the form of a RSVP-TE request. This time however client node R1 includes an indication in the request that the request should be sent via the identified client node (client node R3). This may be achieved by including a loose explicit path in the RSVP-TE request, as will be understood by those skilled in the art.

In FIG. 8 the routing specified in the RSVP-TE request is shown in a balloon (R1-R3 . . . R7). Note that, in this example, the second border node R3 is closer to the client node R1 than the first border node R4. This means that simply by specifying that the request should pass through border node R3, the request will pass through border node R3 before it would pass through border node R4. This avoids the first border node R4 repeatedly sending a failure message back to the first client node and the request never reaching the second border node. However, the other border node may alternatively be “further from” the client node than the first border node and the signalling request can be configured to force the request to pass through the other border node, for example by forcing the request to pass through the other border node before the first border node.

In the example of FIG. 8, the re-sent RSVP-TE request is sent from client node R1 to client node R3 as indicated by a solid black line. When client node R3 receives the RSVP-TE request, it may initiate set up of a new path between border nodes of the client network 10, through the server network 20, according to the steps shown in flow chart 4 as described previously. Preferably, client node R3 initiates set up of a new path from itself, client node R3, through the server network 20, to another border node 30 in the second segment of the client network 10. However, alternatively, it is possible that client node R3 may initiate set up of a new path through the server network 20 from a different border node 30, as described previously.

Note that, in some embodiments, where the border nodes 30 are configured to not normally determine whether they can set up a new path through the server network if there is an alternative route for the request for reservation of resources, the presence of the loose explicit hop or another indicator in the request may indicate to that border node that it should determine whether it can set up a new path through the server network 20 in this instance.

Once the new path is set up (if the new path does have sufficient resources to meet the request), the RSVP-TE request is forwarded over the new path. This new path may also be communicated in the client network 10, so that the new path can be used in subsequent routings between client nodes.

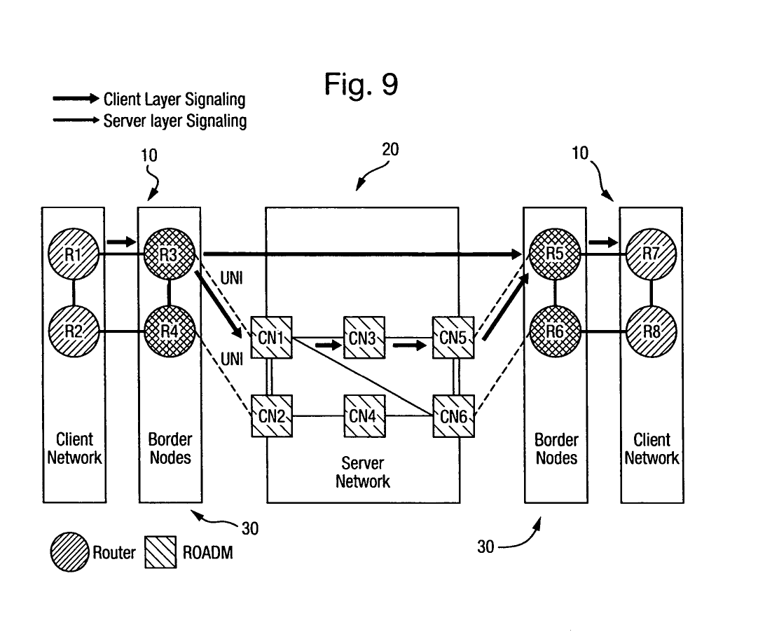

FIG. 9 illustrates an example where a new path is set up from client node R3 through the server network 20, in this case to client border node R5. As indicated by the grey arrows, the new path passes from client node R3 via server nodes CN1, CN3 and CN5 to client node R5, and the RSVP-TE request is forwarded via that path. FIG. 9 indicates the client and server network signalling. In the client network 10, the signalling is seen as passing the request directly from client node R3 to client node R5, as indicated by the solid black arrow. However, in fact, the request is passed from client node R3 to server node CN1, to server node CN3, to server node CN5 and then to client node R5, as indicated by the grey arrows. After reaching client node R5, the request is then passed directly to client node R7. This establishes the resource reservation and so a connection is established between client node R1 and client node R7 ready for subscriber traffic.

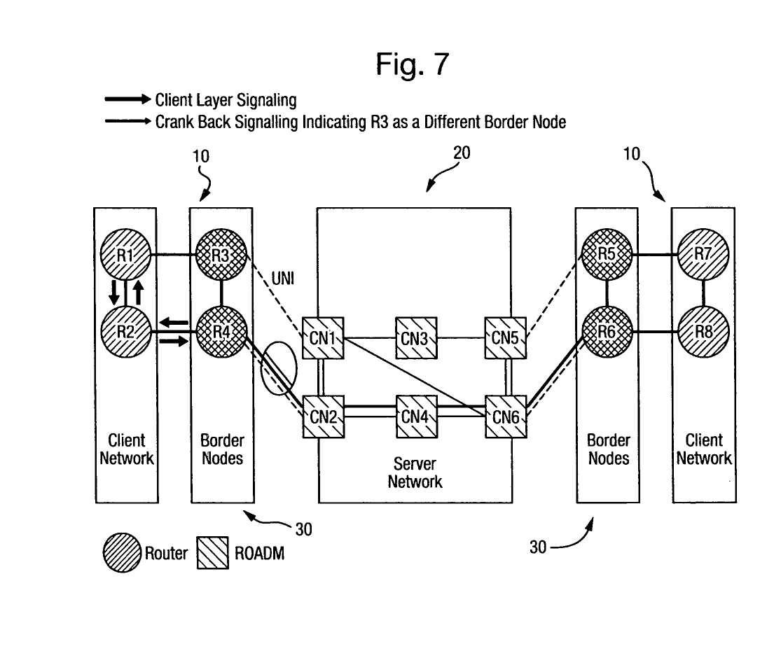

FIG. 10 illustrates a flow chart according to a preferred embodiment of the present invention. As in the flow chart of FIG. 7, at step 1000, a first border node (which has a path for traffic through the server network) receives a request for reservation of resources from a first client node. At step 1010, it is determined that the path does not have sufficient resources to meet the request. Then, at step 1020, the first border node identifies a different (second) border node, which may be able to meet the request. Note that this border node may not have a path for carrying traffic through the server network. At step 1030, the border node sends a message to the first client node identifying the second border node. Preferably, this message comprises an indication that the first client node should resend the request for reservation of resources via the second border node. Then, at step 1040, the first client node receives the message from the first border node, and at step 1050 sends a request for reservation of resources via the second border node. Preferably, the request comprises an indication of the second border node. At step 1060, the second border node receives the request for reservation of resources from the first client node. At step 1070, the second border node (which in this case does not have a path for traffic through the server network) determines that it does not have a path for traffic through the server network having sufficient resources to meet the request and, at step 1080, the second border node initiates set up of a new path between border nodes of the client network through the server network.

Thus, embodiments of the present invention have the advantage that a client node can automatically set up new end-to-end paths through the server network, as and when needed—without waiting for a client network operator to trigger the set up of a new path through the server network.

This is particularly desirable for a software defined network (SDN). SDN networks are currently being developed with the aim of simplifying the operation and management of communications networks by increasing automation and enabling faster introduction of new services. A SDN controller acting as a computer platform may be coupled to a plurality of communications networks by an interface such as an API (application programming interface). Application software may then be distributed by the SDN controller to elements in the network, where the software may be run to perform desired tasks. Embodiments of the present invention enable the set-up of new end-to-end paths through a server network to be triggered by applications running over a client node.

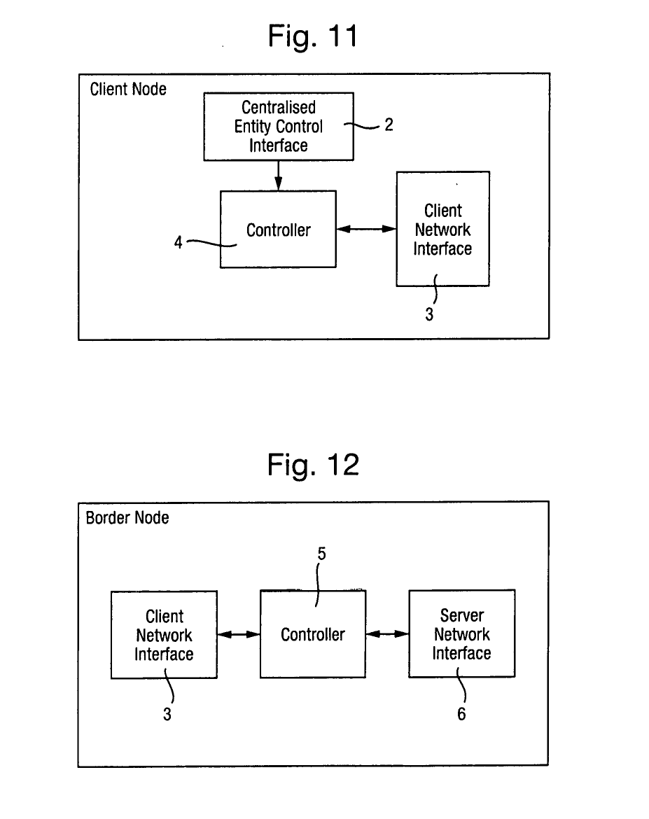

FIG. 11 is a schematic diagram showing some elements of a client node according to a preferred embodiment of the present invention. In this example, the client node comprises an optional interface 2 for receiving instructions to initiate a request for reservation of resources from a centralised entity such as a SDN controller. The instructions may be comprised within application software. The client node further comprises a client network interface 3 for communicating with other nodes in the client network. The client network interface 3 is capable of sending and receiving signalling messages to other client nodes requesting reservation of resources on paths therefrom. There is also a controller 4 coupled to interface 2 and interface 3 which is configured to form requests for reservation of resources according to embodiments of the present invention described above. The controller 4 may comprise a general purpose processor executing machine executable code or one or more dedicated processors or processing apparatus implemented as hardware or a combination of hardware and software, for example in a FFGA (field programmable gate array), an AIC (application specific integrated circuit) or a ASSP (application specific standard product). The controller 4 may comprise one or more modules integrated to any degree.

FIG. 12 is a schematic diagram of a border node 30 of the client network 10 according to a preferred embodiment of the present invention. The node comprises a client network interface 3 for communicating with other nodes in the client network and a server network interface 6 for communicating with the server network, and in particular with its adjacent server node. The node further comprises a controller 5 coupled to the client network and server network interfaces 3, 6 which is configured to perform steps according to embodiments of the present invention described above, to form a signal to initiate set up of a new path for carrying traffic between border nodes of the client network through the server network. Again, the controller 5 may comprise a general purpose processor executing machine executable code or one or more dedicated processors or processing apparatus implemented as hardware or a combination of hardware and software, for example in a FFGA (field programmable gate array), an AIC (application specific integrated circuit) or a ASSP (application specific standard product). The controller 5 may comprise one or more modules integrated to any degree.

1. A method for setting up a new path for carrying traffic between border nodes of a client communications network through a server communications network, the method comprising, at a border node of the client communications network:
receiving a request for reservation of resources from a first client node of the client communications network;
determining that the border node does not have a path for carrying traffic through the server communications network having sufficient resources to meet the request; and,
in response, initiating set up of a new path for carrying traffic between border nodes of the client communications network through the server communications network.

2. A method according to claim 1, wherein the step of initiating set up of a new path for carrying traffic between border nodes of the client communications network comprises initiating set up of a new path between the border node and another border node of the client communications network through the server communications network.

3. A method according to claim 1, wherein the step of initiating set up a new path for carrying traffic between border nodes of the client communications network comprises:
identifying a second border node of the client communications network; and initiating set up of a new path between the second border node and another border node of the client communications network through the server communications network.

4. A method according to claim 3, wherein the step of initiating set up a new path for carrying traffic between the second border and another border node of the client communications network through the server communications network comprises sending a signal to the first client node identifying the second border node.

5. A method according to claim 4, wherein the signal to the first client node comprises an indication that the first client node should re-send its request for reservation of resources via the second border node.

6. A method according to claim 3, wherein the step of identifying the second border node of the client communications network comprises identifying the second border node from a plurality of border nodes of the client communications network based on the proximity of the second border node to the first client node.

7. A method according to claim 1, wherein the request for reservation of resources from the first client node comprises an indication that the border node should initiate set up a new path for carrying traffic between border nodes of the client communications network through the server communications network.

8. A method according to claim 3, wherein the second border node does not have a path for carrying traffic through the server communications network.

9. A method according to claim 1, wherein the border node does not have a path for carrying traffic through the server communications network.

10. A method according to claim 1, wherein the new path for carrying traffic between border nodes of the client communications network through the server communications network is a label switched path.

11. Apparatus for a border node of a client communications network, the border node being coupled to a server communications network, the apparatus comprising:
an interface for receiving a request for reservation of resources from a first client node of the client communications network; and
a controller configured to:
determine that the border node does not have a path for carrying traffic through the server network having sufficient resources to meet the request; and,
in response, form a signal to initiate set up of a new path for carrying traffic between border nodes of the client communications network through the server communications network.

12. Apparatus according to claim 11, wherein the new path is a new path for carrying traffic between the first border node and another border node of the client communications network through the server communications network.

13. Apparatus according to claim 11, wherein the controller is further configured to identify a second border node of the client communications network, and wherein the new path is a new path for carrying traffic between the second border node of the client communications network and another border node of the client communications network through the server communications network.

14. Apparatus according to claim 13, wherein the signal comprises an indication of the second border node.

15. Apparatus according to claim 14, wherein the signal comprises an indication that the first client node should re-send its request for reservation of resources via the second border node.

16. Apparatus according to claim 11, wherein the controller is configured to form the signal to initiate set up of a new path between border nodes of the client communications network through the server communications network, only if the request for reservation of resources from the first client node comprises an indication that the border node should initiate set up a new path for carrying traffic between border nodes of the client communications network through the server communications network.

17. A border node for coupling to a server communications network, the border node comprising apparatus according to claim 11.

18. A method for setting up a new path for carrying traffic between border nodes of a client communications network through a server communications network, the method comprising, at a first client node of the client communications network:
receiving a signal from a border node of the client communications network identifying a second border node of the client communications network; and
sending a request for reservation of resources via the second border node.

19. A method according to claim 18 wherein the signal from the border node of the client communications network indicates that the first client node should re-send a request for reservation of resources via the second border node.

20. A method according to claim 18, wherein the request for reservation of resources via the second border node comprises an indication of the second border node.

21. A method according to claim 20, wherein the request for reservation of resources via the second border node comprises an RSVP-TE request which includes a loose explicit hop identifying the second border node.

22. A method according to claim 18, wherein the request for reservation of resources via the second border node comprises an indication that the second border node should initiate set up of a new path from the second border node through the server communications network.

23. Apparatus for a first client node of a client communications network, the apparatus comprising:
an interface for receiving a signal from a border node of the client communications network identifying a second border node of the client communications network; and
a controller configured to, in response, form a request for reservation of resources comprising an indication that the request should be sent via the second border node.

24. A client node comprising apparatus according to claim 23.

25. A client communications network comprising a border node according to claim 17.

26. (canceled)
